(19) United States
(12) Patent Application Publication
(10) Pub. No.: US 2023/0356157 A1
(43) Pub. Date: Nov. 9, 2023

(54) APPARATUS AND PROCESS FOR PREPARING VISCOUS EDIBLE PASTES

(71) Applicant: STRAUSS GROUP LTD, Petach-Tikva (IL)

(72) Inventors: Dagan Eshel, Yehud (IL); Amit Avigdor, Kibbutz Bahan (IL); Hagai Harduff, Binyamina (IL)

(21) Appl. No.: 18/246,291

(22) PCT Filed: Sep. 30, 2021
(86) PCT No.: PCT/IL2021/051177

§ 371 Date: Mar. 22, 2023

Related U.S. Application Data
(60) Provisional application No. 63/086,071, filed on Oct. 1, 2020.

(51) Int. Cl. B01F 23/41; A23L 11/00; A23L 25/00; B01F 23/47; B01F 35/90

(52) U.S. Cl. CPC B01F 23/41; A23L 11/05; A23L 25/30; B01F 23/47; B01F 35/90; B01F 2035/98; B01F 2101/06

(57) ABSTRACT

The present disclosure concerns apparatus and processes for preparing viscous food products, typically on-demand preparation of single servings of edible, e.g. vegetable-based, pastes having high viscosity.

### TECHNOLOGICAL FIELD

The present disclosure concerns apparatus and processes for preparing viscous food products, typically on-demand preparation of single servings of vegetable-based edible pastes having high viscosity.

### BACKGROUND ART

References considered to be relevant as background to the presently disclosed subject matter are listed below:
US patent application publication no. US2019194009
U.S. Pat. No. 4,759,633
US patent application publication no. US2017240400
Chinese patent application publication no. CN106362638
US patent application publication no. US2016222332
US patent application publication no. US20060249536
US patent application publication no. US20170182470
International patent application publication no. WO2012138582
US patent application publication no. US2018027854
U.S. Pat. No. 6,808,091
U.S. Pat. No. 7,036,687
U.S. Pat. No. 8,327,607
U.S. Pat. No. 5,383,581
U.S. Pat. No. 5,549,222

Acknowledgement of the above references herein is not to be inferred as meaning that these are in any way relevant to the patentability of the presently disclosed subject matter.

### BACKGROUND

With the ever-growing awareness of healthy nutrition and demand for freshly prepared food items, the requirement of vegetarian-based dishes freshly prepared on demand has recently increased. Vegetarian-based edible pastes, such as chickpea paste (i.e. hummus) or other legume pastes, are increasing in popularity, as these are often a source for high quality vegetable-based proteins and essential amino acids.

Typically, preparation of legume pastes is time consuming, as such pastes are often prepared from dried legumes, which require pre-soaking, cooking, processing and flavoring. Therefore, such pastes are often prepared in relatively large batches (that are sufficient for at least a few serving portions). However, as such pastes are often highly sensitive to environmental conditions and start to ferment relatively quickly, large batches of such pastes often remain unconsumed, and are therefore discarded. In addition, as such pastes are often flavored by other ingredients (e.g. spices, other pastes such as sesame paste, various toppings, etc.), it is often required to mix each portion separately to accommodate individual taste and preference, making it hard to tailor each serving and/or control the uniformity of the finished product.

### GENERAL DESCRIPTION

The present disclosure concerns apparatus and processes for preparing viscous food products, typically on-demand preparation of single servings of edible pastes, e.g. vegetable-based edible pastes, having high viscosity, such as single servings of flavored chickpea paste. The apparatus is uniquely designed to permit homogenous mixing of an aqueous-based viscous edible paste with one or more oil-based compositions (e.g. an oil-based edible supplement or condiment) having a significantly lower viscosity, in a hygiene and controllable manner, to thereby produce a final edible paste, typically an emulsion.

The apparatus and processes of this disclosure provide highly tailorable preparation of edible pastes, permitting the user to select and control the ratio between at least some of the ingredients of the edible paste per demand and for each individual serving, such that each serving is freshly prepared upon user specific requirements.

Further, the apparatus is designed to minimize contact of the edible paste with parts of the apparatus in order to prevent accumulation of pastes in various parts of the apparatus that are hard and complex to clean. Hence, the apparatus of this disclosure circumvents (or at least minimizes) risks of fermentation and/or contamination of the ingredients and final product; this is permitted, as will be further explained herein, at least by providing easily replaceable and disposable internal elements of the apparatus.

By one of its aspects, the present disclosure provides an apparatus for on-demand preparation of portioned edible paste, that comprises a container receptacle configured to removably receive a removable container containing a first edible composition in the form of an aqueous-based viscous paste; a reservoir for holding a second edible composition, in the form of an oil-based flowable paste; a static mixing assembly configured to mix the first composition with the second composition in order to obtain the edible paste in the form of an emulsion, a ducting arrangement, one or more propelling modules, and a control module.

The static mixing assembly comprises an inlet arrangement with a first inlet for receiving the first composition and a second inlet for receiving the second composition, an outlet in flow communication with an edible paste dispensing outlet of the apparatus, and a static mixing arrangement disposed between the first and second inlets and said outlet for mixing the first composition with the second composition while advancing within said static mixing arrangement from the inlet arrangement towards the outlet.

The ducting arrangement comprising a first duct configured to link between the removable container and said first inlet, and a second duct configured to link between the reservoir and said second inlet.

According to some embodiments, the first and second inlets have each a predetermined geometrical shape that matches a geometrical shape of a terminus of the first and second ducts, respectively. A potential advantage of such geometrical matching can prevent mistakes when linking the first and second ducts to the static mixing arrangement.

The one or more propelling modules are configured to propel the first composition from said removable container through the first duct into the first inlet, and the second composition from said reservoir through the second duct into the second inlet. Thus, the first and second compositions are propelled, i.e. fed under pressure and/or force-fed, from the removable container and the reservoir into the first and second inlets of the static mixing assembly, respectively, via the respective first and second ducts. The control module activates the one or more propelling modules to propel portioned amounts of the first and second compositions through the static mixing assembly to thereby dispense said portioned edible paste.

The term portioned amount means to denote a consumable amount of the edible paste. Typically the portioned amount of the edible paste is a single serving of the edible paste, i.e. an amount for consuming in a single meal. Hence, the apparatus is configured for batch-wise operation (i.e. not continuous), to sequentially prepare and dispense single servings of the edible paste.

The portion amount can, by some embodiments, be up to 500 g of the edible paste. By other embodiments, the portioned amount ranges between about 100 g and 500 g, e.g. 100 g, 150 g, 200 g, 250 g, 300 g, 350 g, 400 g, 450 g, or 500 g. By some other embodiments, the portioned amount can range between about 100 g and 300 g, between 100 g and 250 g, or even between 100 g and 200 g.

As noted, the apparatus is configured to removably receive a removable container, that holds a first edible composition of a high viscosity. The removable container can be rigid, semi-rigid, or pliable.

Preferably, the removable container is a pliable container.

The term pliable container means to denote a holding vessel that is flexible or semi-flexible, permitting its collapsing during emptying. The pliable container can be made of any suitable material, e.g. one or more polymeric materials. The pliable container is typically made of or coated by one or more food-grade materials, namely materials that are approved for prolonged contact with food. The material may be a single-layer material or a multi-layer material.

By some embodiments, the pliable container is an aseptic container, e.g. an aseptic bag.

The removable, e.g. pliable, container is removably received within a container receptacle of the apparatus. In other words, the container receptacle is configured to temporarily hold the removable container. The removable container is replaceable and can be removed from the apparatus after partial or complete depletion. By some embodiments, the removable container is disposable.

The removable container is sized to hold an amount of the first edible composition sufficient to produce several portioned amounts of the edible paste, e.g. 2, 3, 4, 5, 6, 7, 8, 9, 10 or even more portioned amounts. In some embodiments, the removable container holds an amount of the first composition sufficient to product between 2 and 10 portioned amounts. According to some embodiments, the removable container is sized to hold between about 0.5 kg and about 10 kg of the first composition.

The first composition is an aqueous-based edible composition, in the form of a viscous paste. The term aqueous-based means to denote a composition that comprises at least 50 wt % of water. By some embodiments, the first composition comprises at least 10 wt % of solids, e.g. between 10 wt % and 60 wt % of solids.

The second composition is an oil-based edible composition, in the form of a flowable paste. The term oil-based means to denote a composition that comprises at least 40 wt % of oil (e.g. at least 42 wt %, 45 wt %, 48 wt %, 50 wt %, 55 wt %, or even more than 60 wt % of oil). By some embodiments, the second composition comprises at least 10 wt % of solids, e.g. between 10 wt % and 60 wt % of solids.

The static mixing assembly is configured to mix the first and second compositions in order to form an edible paste, which is in the form of an emulsion. Within the context of the present disclosure, emulsion refers to a fine dispersion of the first composition within the second composition, or vice-versa. In other words, as the first composition is aqueous-based and the second composition is oil-based, the compositions are immiscible one in the other. Hence, the static mixing assembly is configured for concomitant forced flowing of the first composition and the second composition to finely particulate them and disperse one of the compositions within the other. Formation of an emulsion provides relatively long stability, i.e. no visible phase separation, as well as homogeneity of dispersion of the second composition and the first composition one into the other. Depending on the ratio between the first composition and the second composition, an oil-in-water emulsion (O/W, in which the oil forms droplets in a continuous aqueous phase) or a water-in-oil (W/O, in which water forms droplets in a continuous oily phase) can be obtained. According to some embodiments, the emulsion is an oil-in-water emulsion.

By some embodiments, at least one of said first composition and said second composition is plant-based. According to other embodiments, both the first composition and the second composition are plant-based.

A plant-based composition is a food composition which consists predominantly of plant-based edible ingredients, i.e. ingredients which are originated from edible plants or vegetative material(s).

According to some embodiments, the first composition is a plant-based legume paste. The first composition can, by some embodiments, comprises at least one legume selected from chickpeas, lentils, beans, soybeans, broad beans, peas, peanuts, their edible horticultural and/or wild varieties.

According to other embodiments, the legume paste is a chickpea paste, lentils paste, a bean paste, a soybean paste, a broad bean paste, peas paste, peanuts paste, and any mixture thereof. By some other embodiments, the legume paste is a chickpea paste. By further embodiments, the legume paste is lentils paste. By some further embodiments, the legume paste is beans paste.

According to some embodiments, the first composition comprises at least 10 wt % of legumes, i.e. at least 10 wt % of solids within the first composition originating from legumes. According to other embodiments, the first composition can comprise at least 11 wt %, at least 12 wt %, at least 13 wt %, at least 14 wt %, at least 15 wt %, at least 16 wt %, at least 17 wt %, at least 18 wt %, at least 19 wt %, or even at least 20 wt %. According to other embodiments, the first composition can comprise between about 10 wt % and 40 wt % legumes.

Although predominantly constituted one or more legumes, the first composition can further comprise one or more vegetable oils, one or more flavoring additives, one or more preservatives, one or more antioxidants, one or more emulsifiers, or any other food-safe additive.

As noted, the first composition is a high viscosity paste. According to some embodiments, the first composition has a viscosity of at least about 2,000 cps (centipoise). By some embodiments, the first composition has a viscosity of between about 2,000 cps and about 40,000 cps. According to other embodiments, the first composition can have a viscosity of between about 2,500 cps and 25,000 cps.

It is noted that viscosity values defined throughout this disclosure are provided at a temperature of 20-25° C., unless specifically noted otherwise.

According to some embodiments, the second composition is a plant-based composition. Unlike the first composition, the second composition is an oil-based flowable paste, having a viscosity of at most 5,000 cps, e.g. between about 30 cps and about 5,000 cps. According to other embodiments, the second composition can have a viscosity of between about 100 cps and 3,000 cps. The second composition is typically a flavoring composition, which comprises one or more flavoring ingredients, and provides additional flavor to the first composition once mixed therewith to provide the edible paste.

According to some embodiments, the first composition has a viscosity larger by at least 1000 cps from the viscosity of the second composition, e.g. larger by at least 1200 cps, 1500 cps, 2000 cps, or even 2500 cps.

By some embodiments, the second plant-based edible composition is a sesame paste (e.g. tahini), oil, flavored oil, oily-liquid spices blend, oil-based dressing (such as vinaigrette), etc.

The first and second compositions, by other embodiments, can be non-vegetative (i.e. not plant-based).

The second composition is held in a reservoir within the apparatus, from which metered amounts of the second composition can be drawn for the preparation of a portion of the edible paste. The reservoir can be removable, e.g. for replacement or cleaning, or can be fixed within the apparatus. Typically, the reservoir is re-fillable, such that the second composition can be replenished. The reservoir can be directly fillable, i.e. through a filling opening. Alternatively, the reservoir can be configured to receive collapsible removable containers that hold the second composition and can be replaced upon partial or complete depletion.

By some other embodiments, the reservoir can be rigid, semi-rigid or pliable reservoir.

By some embodiments, the reservoir is rigid or semi-rigid, and comprises one or more mixing elements for continuously mixing the second composition, e.g. to prevent phase separation or sedimentation of particulate matter. For example, in the case the second composition is tahini, care should be taken to prevent separation of the oily phase from the ground sesame particles—hence, continuous mixing of the contents of the reservoir is preferably carried out.

According to some embodiments, the apparatus is configured to mix said second composition into the first composition at a weight percentage ranging between about 5 wt % and about 50 wt % of the second composition out of the total weight of the portioned edible paste.

One of the challenges in on-demand preparation of edible products is maintaining the hygeniety of internal elements of the apparatus while also producing consistent and homogenous product. For this purpose, the apparatus of this disclosure utilizes an arrangement of internal elements which are easily replaceable, as well as propulsion mechanisms that do not come in direct contact with the food ingredients.

The mixing arrangement that permits mixing of the first and second compositions is based on static mixing, i.e. causing the compositions to mix (or blend) within a mixing unit that has no moving parts. Static mixing is based on concomitantly force-feeding the compositions into a static mixer unit, that typically comprises an array of flow diverters or baffles, such that the compositions are forced to intermix as they flow along the static mixer.

Thus, the static mixing assembly of the apparatus comprises an inlet arrangement with a first inlet for receiving the first composition and a second inlet for receiving the second composition, an outlet in flow communication with an edible paste dispensing outlet of the apparatus, and a static mixing arrangement disposed between the first and second inlets and said outlet for mixing the first composition with the second composition while advancing within said static mixing arrangement from the inlet arrangement towards the outlet. The static mixing arrangement typically includes a tube casing that comprises an array of flow diverters or baffles. The tube casing can be a substantially linear tube, or can be a bended tube, defining one or more bends that permit a compact arrangement of the static mixing arrangement (e.g. a C-shaped, U-shaped, W-shaped, or any other suitable shaped tube).

According to some embodiments, the static mixing arrangement is U-shaped, with the first and second inlets being positioned at a terminal segment of one of the arms of the U shape, and the outlet being positions at a terminal segment of the other one of the arms of the U shape.

By some embodiments, the static mixing assembly further comprises one or more auxiliary mixing elements, for example a vibrator element or an ultrasonic element that can apply vibrations at various frequencies to the static mixing arrangement, thereby assisting in said mixing.

By some embodiments, the static mixing arrangement is disposable, and can be easily replaced after several cycles of operation of the apparatus (for example, whenever a removable container is replaced, the static mixing arrangement can be replaced as well).

The removable, e.g. pliable, container and the first inlet are linked or linkable by a first duct, while the reservoir is linked or linkable to the second inlet by a second duct. By some embodiments, the first duct, the second duct and the static mixing arrangement are disposable. According to some embodiments, the first duct, the second duct and the static mixing arrangement are integral with one another, and form a single replaceable unit.

By other embodiments, the static mixing arrangement is an integral part of the apparatus.

The first and second ducts are typically flexible tubing, made of or coated by a food-safe material.

Each of the first and second ducts is associated with a propelling module that is configured to propel the first composition from said removable container through the first duct into the first inlet, and the second composition from said reservoir through the second duct into the second inlet.

According to some embodiments, the one or more propelling modules are one or more pumps.

According to some other embodiments, the one or more propelling modules are peristaltic pumps. Peristaltic pumps are positive displacement pumps, that are designed to force movement of a fluid within a flexible tube by externally applying pressure on the tube. The part of the tube under compression is closed, forcing the fluid within the tube to advance forward along the tube. Thus, propulsion of the first and second compositions through the ducts and within the static mixing arrangement can be obtained without bringing the food ingredients into contact with the propulsion means.

As noted, by some embodiments, the removable container that holds the first edible composition is a pliable container. As the first composition has a high viscosity, the container receptacle may further comprise, by some embodiments, an auxiliary propelling arrangement, configured for externally exerting a squeezing force onto the pliable container to thereby push the first composition towards the first duct. According to some embodiments, the auxiliary propelling arrangement comprises one or more rollers. The one or more rollers are configured to rollably incrementally displace along the external surface of the pliable container, thereby applying force onto the pliable container to move portions of the first composition outward from the container when a demand for edible paste is received.

By some embodiments, said container receptacle comprises one or more sensors, configured to sense the position of said one or more rollers, such that the position of the one or more rollers provides indication on the remaining content of the first composition in the pliable container. Thus, the position of the one or more rollers can indicate the time to replace the pliable container, provide indication to the control module about the utilization rate of the pliable container, etc.

According to the position of the one or more rollers, the control module can issue a command to lock the apparatus. For example, when the roller has not displaced for a predetermined period of time, such can indicate that no demand for edible paste has been received during said period of time, meaning that the pliable container needs to be replaced with a fresh one in order to prevent fermentation or contamination of the food ingredients. In case the period of time exceeds a predefined threshold, the control unit can prevent the apparatus from receiving a demand for preparation and initiating an operation cycle until a pliable container has been replaced.

In addition to the propulsion arrangement, the pliable container may have a structural design that assists in directing the viscous first composition to flow out of the container. According to some embodiments, the pliable container has a top end configured for coupling to the container receptacle, a bottom end defining a confined volume containing said first composition, and a fitting at said bottom end for coupling to said first duct. The top end, by some embodiments, has a horizontal edge, and the bottom end has a slanted edge, downwardly extending from a first edge portion at one side of the container to a second edge portion at a second side of the container, said fitting being formed in a portion proximal to said second edge portion. In other words, the bottom end of the pliable container is downwardly slanted towards a drainage zone of the pliable container, and the outlet fitting is positioned in the drainage zone. Thus, when the first composition is forced out of the pliable container, the first composition will be directed by the slanted bottom end towards the drainage zone, assisting in complete depletion of the content of the pliable container.

When the container receptacle comprises said one or more rollers, the rollers are configured for movement along a side of the container from said top end towards the bottom end to thereby exert a squeezing force onto the pliable container for pushing the first composition towards the fitting.

The first duct may comprise a fitment end, and the fitting of the pliable container is configured to be irreversible ruptured by the fitment end during coupling of the first duct to the pliable container. By some embodiments, the fitment end is configured to sealingly fit within the fitting of the pliable container, thereby minimizing or preventing undesired leakage of the first composition from the fitting.

As the pliable container is removable, the pliable container may include a coupling arrangement at its top end, and the container receptacle can include a respective suitable coupling means to coordinate with the coupling arrangement. By some embodiments, the container receptacle comprises two or more pins and the pliable container has holes at its top end configured for fitting over said pins.

It is of note that a pliable container suitable for the apparatus described herein is an additional aspect of the present disclosure.

As noted, the apparatus comprises a control module for operating the apparatus and controlling its proper function. The control module can further be configured to receive and process data carried by the removable container, e.g. type of composition, batch number and production date, expiration or usable date, size of container, authentication means, etc. Thus, the removable container can comprise one or more data-carrying means, for example RFID tag, QR code, barcode, etc., and the control module accordingly comprises one or more suitable data-reading means. In embodiments where the reservoir is a removable reservoir, the reservoir can also carry such data-carrying means.

The control module is, by some embodiments, in communication with a user interface module. The user interface module can comprise one or more operation buttons, touch-buttons, keyboard, or auditory system (e.g. a microphone or pick-up) permitting the user to selectively enter a demand for preparation of a portion of the edible paste, as well as various indication means (e.g. visual or auditory indication means or visual display) providing various indications and information to the user or operator during operation of the apparatus.

By some embodiments, the control module permits selection of one or more of the portion-size of the portioned edible paste and the relative amounts of the first and second compositions.

The control module can further be programmed to provide the user with additional information, such as data indicative to the nutritional values of the portion of the edible paste, e.g. according to the specific selection of the ratio between the first and second compositions, indication about the progression of the preparation process, the remainder of composition in the removable container and/or the reservoir, the status of the mixing arrangement, indication about the time/cycles remaining until replacement of the static mixing arrangement, expiry date of the first and/or second compositions, temperature of the first and/or second composition, etc.

The control module can also be configured to communicate with a remote service center, e.g. via wired or wireless communication utility, thereby transmitting and receiving data to/from the service center. The control module can communicate various data to the service center, for example the production capacity of the apparatus (e.g. how many servings were produced at a given time interval, how much first and/or second compositions were consumed, etc.), how many pliable containers have been used, indication on replacement of a removable container and/or reservoir, power utilization of the apparatus, indications on malfunctions, indication concerning mixing arrangement replacement, etc.

The apparatus may further comprise at least one refrigeration module for refrigerating one or more of the first composition, the second composition or the edible paste. In some embodiments, the refrigeration module is configured to change the temperature and/or keep the entire apparatus in the selected temperature. In some embodiments, the refrigeration module cools and maintains at least part of the apparatus or the entire apparatus at a temperature selected according to FDA 2011. Fish and Fishery Products Hazards and Control s Guidance. 4^{th} Edition, for example to allow a food exposure time of up to 7 hours, for example up to 10 hours, up to 12 hours, up to 24 hours, up to 7 days or any intermediate exposure time. In some embodiments, the selected temperature is different from ambient temperature, for example the temperature of air surrounding the apparatus. According to some embodiments, the refrigeration module is configured to lower and/or to maintain the temperature of one or more of the components of the apparatus to a temperature, for example, lower than about 15° C., lower than about 10° C., or even lower than about 8° C. In some embodiments, the refrigeration module cools and maintains at least part of the apparatus or the entire apparatus at a temperature in a range of about 4° C.-12° C., for example in a range of about 4° C.-6° C., 4° C.-8° C., 5° C.-9° C., etc.

According to some embodiments, the control module is configured to prevent preparation of a portion of the edible paste in case the temperature of the first composition, the second composition or the edible paste exceeds a predefined threshold.

According to some embodiments, the apparatus can further comprise a temperature regulation module associated with the static mixing arrangement or the dispensing outlet, for heating the edible paste to a temperature of 19° C.-35° C., e.g. a consumption temperature.

The apparatus may further comprise or be associated with one or more holding/serving containers dispensing modules, that dispense a holding/serving container for receiving the dispensed edible paste. By selecting a portion size, the control module can operate the containers dispensing modules to dispense a properly sized holding/serving container. The apparatus may further comprise one or more sensors indicating proper placement of the holding/serving container below the apparatus outlet and/or verifying that a properly sized holding/serving container is utilized prior to dispensing the edible paste from the apparatus.

The apparatus can further comprise or be associated with one or more labeling modules, configured to dispense a data label (e.g. a sticker) for attaching to the holding/serving container, the data being specific to the portioned edible paste (e.g. date and hour of preparation, final composition, nutritional data, best-by date, etc.). Alternatively, the one or more labeling modules can be configured to print or stamp the relevant data directly onto the holding/serving container.

The apparatus can further comprise one or more additional ingredients reservoirs or removable containers, e.g. for dispensing one or more additional food ingredients into the static mixing arrangement or one or more toppings to be dispensed directly onto the edible paste after its preparation. By other embodiments, the reservoir of said second composition may comprise a secondary outlet, linked or linkable to the edible paste dispensing outlet, for dispensing a portion of said second composition below or on top of the edible paste.

The apparatus can further comprise or be associated with a weighing module, configured for weighing the edible paste during and/or after dispensing.

The apparatus can further comprise one or more payment means associated with the user interface and/or the control module, to actuate the apparatus for preparation of a portion of edible paste only after payment confirmation.

It is to be understood that the apparatus described herein is non-industrial, and is not intended for industrial preparation of the edible paste. The apparatus described herein is designed and intended for domestic, point-of-sale or commercial use (e.g. in a restaurant, supermarket, shopping facility, etc.). According to some embodiments, the apparatus is configured to dispense up to 1000 portions of edible paste per day, for example up to 200 portions per day, up to 80 portions per day, or even up to 50 portions per day.

In some embodiments, the apparatus is a countertop apparatus, having a housing which is shaped and sized to be placed on a table or countertop. In some embodiments, a base of the housing has a surface area of up to 2500 cm², for example up to 2000 cm², up to 1500 cm², or even up to 1000 cm².

By another one of its aspects, the present disclosure provides an apparatus for preparing portioned edible paste on-demand, the apparatus comprising a container receptacle holding a removably receivable pliable container containing a first composition in the form of an aqueous-based viscous paste; a reservoir holding a second composition, in the form of an oil-based flowable paste; a static mixing assembly configured to mix the first composition with the second composition in order to obtain said edible paste in the form of an emulsion, the static mixing assembly having an inlet arrangement with a first inlet for receiving said first composition and a second inlet for receiving said second composition, an outlet in flow communication with an edible paste dispensing outlet of the apparatus, and a static mixing arrangement disposed between said first and second inlets and said outlet for mixing the first composition with the second composition while advancing within said static mixing arrangement from the inlet arrangement towards the outlet; a ducting arrangement comprising a first duct configured to link between said pliable container and said first inlet, and a second duct configured to link between said reservoir and said second inlet; one or more propelling modules for propelling (i) the first composition from said pliable container through the first duct into the first inlet, and (ii) the second composition from said reservoir through the second duct into the second inlet; and a control module for activating the one or more propelling modules to propel portioned amounts of the first and second compositions through the static mixing assembly to thereby dispense said portioned edible paste.

By another one of its aspects, the present disclosure provides an apparatus for preparing portioned edible paste on-demand, the apparatus comprising a container receptacle holding a removably receivable pliable container containing a first, plant-based edible composition in the form of an aqueous-based viscous paste having a viscosity of at least 2000 cps; a reservoir holding a second, plant-based edible composition, in the form of an oil-based flowable paste having a viscosity of at most 5000 cps, the viscosity of the first composition being larger than the viscosity of the second composition by at least 1000 cps; a static mixing assembly configured to mix the first composition with the second composition in order to obtain said edible paste in the form of an emulsion, the static mixing assembly having an inlet arrangement with a first inlet for receiving said first composition and a second inlet for receiving said second composition, an outlet in flow communication with an edible paste dispensing outlet of the apparatus, and a static mixing arrangement disposed between said first and second inlets and said outlet for mixing the first composition with the second composition while advancing within said static mixing arrangement from the inlet arrangement towards the outlet; a ducting arrangement comprising a first duct configured to link between said pliable container and said first inlet, and a second duct configured to link between said reservoir and said second inlet; one or more propelling modules for propelling (i) the first composition from said pliable container through the first duct into the first inlet, and (ii) the second composition from said reservoir through the second duct into the second inlet; and a control module for activating the one or more propelling modules to propel portioned amounts of the first and second compositions through the static mixing assembly to thereby dispense said portioned edible paste.

By another one of its aspects, the present disclosure provides an apparatus for preparing portioned edible paste on-demand, the apparatus comprising a container receptacle holding a removably receivable pliable container containing a first, plant-based edible composition in the form of an aqueous-based viscous paste having a viscosity of at least 2000 cps; a reservoir holding a second, plant-based edible composition, in the form of an oil-based flowable paste having a viscosity of at most 5000 cps; a static mixing assembly configured to mix the first composition with the second composition in order to obtain said edible paste in the form of an emulsion, the static mixing assembly having an inlet arrangement with a first inlet for receiving said first composition and a second inlet for receiving said second composition, an outlet in flow communication with an edible paste dispensing outlet of the apparatus, and a static mixing arrangement disposed between said first and second inlets and said outlet for mixing the first composition with the second composition while advancing within said static mixing arrangement from the inlet arrangement towards the outlet; a ducting arrangement comprising a first duct configured to link between said pliable container and said first inlet, and a second duct configured to link between said reservoir and said second inlet; one or more propelling modules for propelling (i) the first composition from said pliable container through the first duct into the first inlet, and (ii) the second composition from said reservoir through the second duct into the second inlet; and a control module for activating the one or more propelling modules to propel portioned amounts of the first and second compositions through the static mixing assembly to thereby dispense said portioned edible paste.

By a further aspect, there is provided a pliable container configured for holding a first edible composition (e.g. a plant-based edible composition) in the form of an aqueous-based viscous paste having a viscosity of at least 2000 cps, suitable for use with an apparatus as described herein.

According to some embodiments, the pliable container has a top end configured for coupling to the container receptacle, a bottom end defining a confined volume containing said first plant-based edible composition, and a fitting at said bottom end for coupling with a first duct of the apparatus. The top end, by some embodiments, has a horizontal edge, and the bottom end has a slanted edge, downwardly extending from a first edge portion at one side of the container to a second edge portion at a second side of the container, said fitting being formed in a portion proximal to said second edge portion.

According to some embodiments, the fitting of the pliable container is configured to be irreversible ruptured by a fitment end of the first duct of the apparatus during coupling of the first duct to the pliable container. By some embodiments, the fitting of the pliable container is configured for tight fitting about the fitment end.

According to other embodiments, the pliable container may include a coupling arrangement at its top end, configured for removable coupling with the apparatus.

By some embodiments, the pliable container is an aseptic container, e.g. an aseptic bag. By some embodiments, the pliable container is disposable.

In some embodiments, the pliable container holds an amount of the first composition sufficient to product a plurality of portioned amounts of edible paste, e.g. between 2 and 100 portioned amounts. The pliable container, by some embodiments, can hold an amount of the first composition sufficient to produce at least 2, at least 5, at least 10, at least 15, at least 20, at least 25, at least 30, at least 35, at least 40, at least 45, or even at least 50 portioned amounts of the edible product. According to some embodiments, the pliable container is sized to hold between about 0.5 kg and about 5 kg of the first composition.

The pliable container can, by some embodiments, comprise one or more data-carrying means, for example RFID tag, QR code, barcode, etc., that are suitable for reading by one or more appropriate data-reading means and processing the data by a control module of the apparatus (e.g. data indicating, for example, type of composition, batch number and production date, expiration or usable date, size of container, authentication means, etc.).

By another one of its aspects, the present disclosure provides a process for preparing of a portioned edible paste on-demand in a cycle of operation, the cycle comprising:
drawing a portion of a first composition from a removable container that is removably received within a container receptacle of an apparatus for preparing portioned edible paste on-demand, the first composition being in the form of an aqueous-based viscous paste;
simultaneously drawing a portion of a second composition from a reservoir of the apparatus, the second composition being in the form of an oil-based flowable paste;
transferring the first and second compositions, through a ducting arrangement of the apparatus, into a static mixing assembly of the apparatus and causing the first and second compositions to mix therein during forced flow of the first and second compositions along a path from an inlet arrangement of the assembly, through a static mixing arrangement, towards an outlet thereof, thereby forming a portion of said edible paste in the form of an emulsion; and
dispensing the edible paste.

According to some embodiments, the first composition has a viscosity of a at least about 2,000 cps, e.g. between about 2,000 cps and about 40,000 cps.

According to other embodiments, the second composition has a viscosity of at most about 5,000 cps, e.g. between about 30 and about 5,000 cps.

According to some other embodiments, the first composition has a viscosity larger by at least 1,000 cps from the viscosity of the second composition.

By some embodiments, the portion of the first composition and the portion of the second composition are user-determinable. Hence, by some embodiments, the process further comprises user-selection of the portions of the first and second compositions and/or the ratio therebetween.

By some embodiments, the apparatus further comprises a user interface, and the process comprises receiving a demand from a user, through the user interface, for preparation of a portion of the edible paste.

According to some embodiments, the drawn portion of the second composition ranges between about 5 wt % and about 50 wt % of the total weight of the edible paste.

By some embodiments, the apparatus further comprises a control module, and upon receipt of said demand, the control module activates one or more propelling modules within the apparatus for propelling the portioned amounts of the first and second compositions through the static mixing assembly.

According to further embodiments, the process comprises operating the user-interface to select one or more of the portion-size of the portioned edible paste, and the relative amounts of the first and second compositions.

According to some further embodiments, the process comprises presenting to the user, via said user interface, one or more of the following parameters:
(i) the selected portion size of the portioned edible paste,
(ii) the selected relative amounts of the first and second compositions,
(iii) data indicative to the nutritional values of the portion of the edible paste;
(iv) progression of the process;
(v) the remainder amount of first and/or second composition in the removable container and/or the reservoir, respectively;
(vi) the expiry date of the first and/or second compositions; and/or
(vii) the temperature of the first and/or second compositions.

In accordance with some embodiments, the removable container is a pliable container and drawing of said portion of first composition from the pliable container is assisted by an auxiliary propelling arrangement, externally exerting a squeezing force onto the pliable container to thereby push the first composition out of the pliable container during said drawing. In such embodiments, the auxiliary propelling arrangement may comprise one or more rollers, and the exertion of squeezing force is permitted by rolling the one or more rollers along the pliable container.

In accordance with some embodiments, the process comprises continuously mixing said second composition within said reservoir.

By embodiments, the apparatus comprises a refrigeration module, and the process comprises refrigerating one or more of the first composition, the second composition or the edible paste.

Each cycle can, by some embodiments, be configured to dispense a single serving of the portioned edible paste. By some embodiments, the apparatus is configured for operation in consecutive cycles of operation, permitting preparation and dispensing of a plurality of single servings in a sequence, hence the process comprises preparation of a sequence of single serving portions of the edible paste.

In some embodiments, a time interval between the dispensing of two consecutive portions of edible paste is at least 5 seconds, for example at least 10 seconds, at least 20 seconds, or more, or any intermediate time interval.

According to some embodiments, the process comprises replacing said removable container after a pre-determined number of operation cycles.

According to some other embodiments, the removable container, the ducting arrangement and the static mixing arrangement are integral with one another, and the process comprises replacing said removable container, ducting arrangement and static mixing arrangement after a pre-determined number of operation cycles.

As used herein, the term about is meant to encompass deviation of ±10% from the specifically mentioned value of a parameter, such as temperature, pressure, concentration, etc.

Whenever a numerical range is indicated herein, it is meant to include any cited numeral (fractional or integral) within the indicated range. The phrases ranging/ranges between a first indicate number and a second indicate number and “ranging/ranges from” a first indicate number “to” a second indicate number are used herein interchangeably and are meant to include the first and second indicated numbers and all the fractional and integral numerals therebetween.

As will be appreciates, the processes described herein involve numerous process steps which may or may not be associated with other common physical-chemical processes so as to achieve the desired product. Unless otherwise indicated, such process steps, if present, may be set in different sequences without affecting the workability of the process and its efficacy in achieving the desired end result.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination or as suitable in any other described embodiment of the invention. Certain features described in the context of various embodiments are not to be considered essential features of those embodiments, unless the embodiment is inoperative without those elements.

Although the apparatus and processes have been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

Unless otherwise defined, all technical and/or scientific terms used herein have the same meaning as commonly understood by one of ordinary skill in the art to which the invention pertains. Although processes and materials similar or equivalent to those described herein can be used in the practice or testing of embodiments of the invention, exemplary processes and/or materials are described below. In case of conflict, the patent specification, including definitions, will control. In addition, the materials, processes, and examples are illustrative only and are not intended to be necessarily limiting.

### BRIEF DESCRIPTION OF THE DRAWINGS

In order to better understand the subject matter that is disclosed herein and to exemplify how it may be carried out in practice, embodiments will now be described, by way of non-limiting example only, with reference to the accompanying drawings, in which:

FIG. 1 shows a perspective view of an apparatus according to an exemplary embodiment of this disclosure.

FIG. 2 shows a front view of the apparatus of FIG. 1, with the front door removed for ease of viewing of internal arrangements.

FIG. 3A is an isolated perspective view of a pliable container, according to an embodiment of this disclosure, associated with the container receptacle.

FIGS. 3B-3C are, respective, front and back perspective views of the pliable container, with the first duct attached and detached therefrom.

FIG. 4 shows a perspective view of the reservoir of the second composition in isolation, with the reservoir made transparent to view internal parts thereof according to an embodiment of this disclosure.

FIG. 5A shows a front view of the static mixing assembly in isolation, according to an embodiment of this disclosure.

FIG. 5B shows the static mixing arrangement of the static mixing assembly of FIG. 5A.

FIGS. 6A-6B show the static mixer according to an embodiment of this disclosure in isolation, in perspective view (FIG. 6A) in cross sectional view (FIG. 6B) along line I-I in FIG. 6A.

FIG. 7 is a block diagram of an exemplary process according to an embodiment of this disclosure.

### DETAILED DESCRIPTION OF EMBODIMENTS

An exemplary apparatus will now be described according to an embodiment of this disclosure.

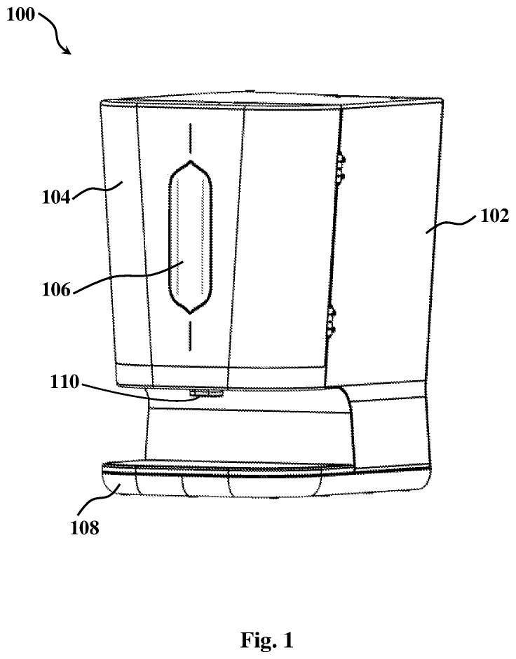

Turning first to FIG. 1, seen in an apparatus 100, having a housing 102, with a front door 104 permitting access to the internal volume defined by the housing. While the specific example shows a front openable door, it is appreciated that the openable door can also be positioned at one of the sides of the housing or in the back of the housing, or even as an openable or removable top panel of the housing.

Associated with door 104 is user interface 106, which in this specific example is a touchscreen. A person of the art may appreciate that while in this specific example the user interface is located on the front door, the user interface can also be positioned at any other user-accessible area of the apparatus, e.g. the top panel of the housing.

User interface 106, which is in communication with a control module (not shown), can comprise one or more operation buttons, touch-buttons, keyboard, and/or auditory system (e.g. a microphone or pick-up) permitting the user to selectively enter a demand for preparation of a portion of the edible paste, as well as various indication means (e.g. visual or auditory indication means or visual display) providing various indications and information to the user or operator.

The housing also defines a base 108, which is configured to receive an edible paste receiving/holding container, e.g. a plate, a food container, a bowl, etc. (not shown). Apparatus dispensing outlet 110 is located above the base 108, thereby permitting dispensing of the edible paste into a receiving container that is placed onto base 108. While in the apparatus of this specific example one dispensing outlet 110 is shown, it is appreciated that more than one dispensing outlet can be provided.

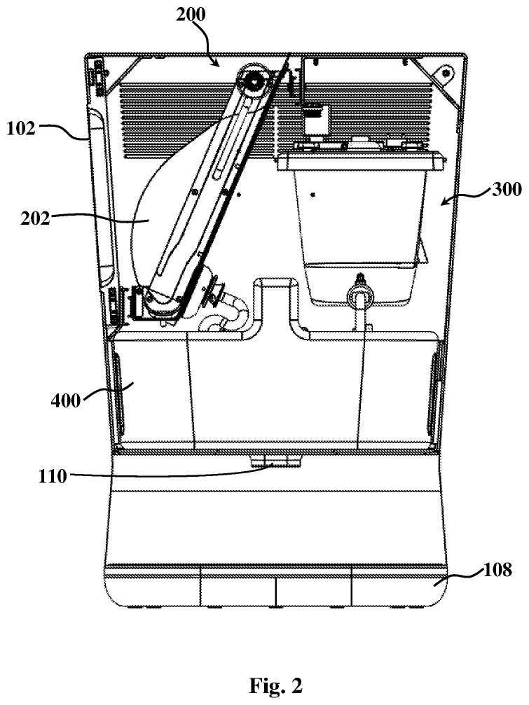

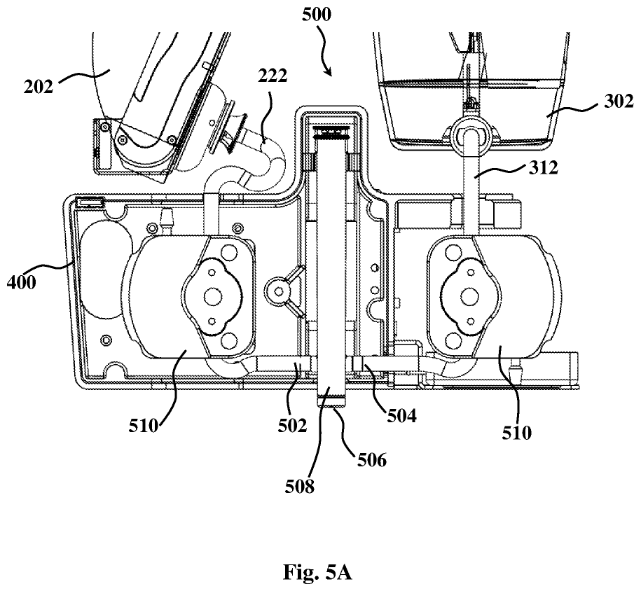

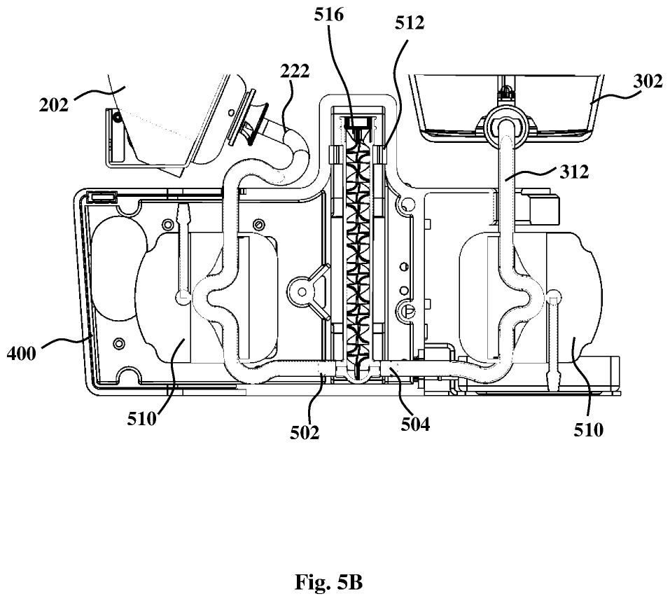

FIG. 2 shows the apparatus of FIG. 1, with the front door 104 removed. Seen is container receptacle assembly, generally designated 200, with removable container 202 received therein, reservoir assembly 300 and cooling arrangement 400 that, in this specific example, encases the static mixing assembly, and portions of the ducting arrangement and the propelling modules, as can be better seen in FIGS. 5A-5B and as will be further detailed below.

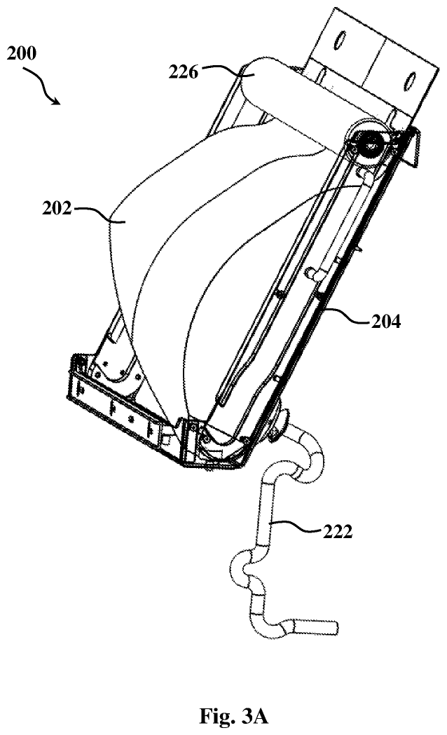

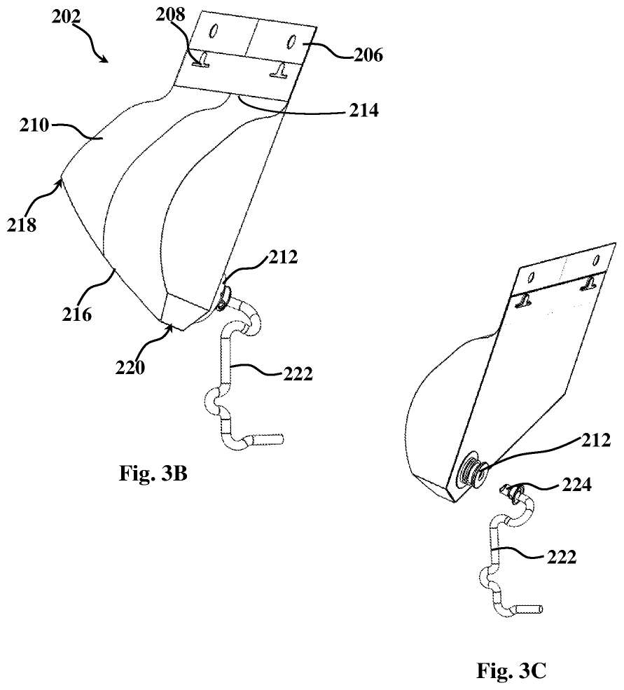

Container receptacle assembly 200 is seen in isolation in FIG. 3A. Container receptacle 204, which in this specific example is in the form of a constructional frame, is associated with removable container 202, which in this specific example is a pliable container. The pliable container is typically an aseptic container (e.g. an aseptic bag) and is typically made of a food-safe material. The pliable container is flexible or semi-flexible, permitting its collapsing during emptying. The pliable container holds a first, typically plant-based, edible composition that is typically aqueous-based and has a viscosity of at least 2,000 cps, e.g. chickpea paste (hummus) having a viscosity of between about 3,000 to 10,000 cps. The chickpea paste is based on water-soaked legumes (i.e. chickpea seeds), and typically contains between 10 and 30 wt % solids in an aqueous matrix.

The pliable container 202 is typically sized to hold an amount of the viscous first composition sufficient to produce several portioned amounts of the edible paste, e.g. 2, 3, 4, 5, 6, 7, 8, 9, 10 or even more portioned amounts, for example, the pliable container can sized to hold between about 0.5 kg and about 10 kg of the first composition, enabling sequentially preparing several single servings size portions of the edible paste (e.g. of between 100 g and 500 g).

In order to assists the extraction of the viscous first composition from the pliable container, as well as maximize the utilization of the pliable container with minimum amount of first composition remaining in the pliable container at the end of use, the container can have a design that permits the viscous first composition to be drained towards the outlet of the pliable container. Such a design in shown in FIGS. 3B-3C. Pliable container 202 of this specific example has a top end 206 configured for coupling to the container receptacle 204 via holes 208 that are sized to removably fit over matching pins of the container receptacle (not shown). Bottom end 210 defining a confined volume for containing the first edible composition, fitting 212 defines the outlet of the pliable container, permitting drawing the first composition from the pliable container therethrough, as will be further explained. The top end 206 has a horizontal edge 214, and the bottom end 210 has a slanted edge 216, downwardly extending from a first edge portion 218 at one side of the container to a second edge portion 220 at a second side of the container, with fitting 212 formed proximal to second edge portion 220.

First duct 222 is shown to be linked (or coupled) to the fitting 212. First duct 222, as better seen in FIG. 3C, can comprise a fitment end 224, and the fitting 212 is configured to be irreversible ruptured by fitment end 224 during coupling of the first duct 222 to the pliable container 202.

The pliable container 202 can comprise one or more data-carrying means (not shown), for example RFID tag, QR code, barcode, etc., for providing one or more data parameters (e.g. type of composition, batch number and production date, expiration or usable date, size of container, authentication means, etc.). The control module of the apparatus accordingly comprises one or more suitable data-reading means (not shown).

In this specific example, in addition to the propulsion modules configured to draw portioned amounts of first composition from container 202, as will be described and exemplified further below, the container receptacle 204 of this example further includes an auxiliary propelling arrangement, i.e. roller 226. Roller 226 is configured for incremental movement along the side of the container from top end 206 towards the bottom edge 216, exerting a squeezing force onto the pliable container 202 to push the viscous first composition towards the fitting 212 and into first duct 222. One or more sensors (not shown) can be positioned along the container receptacle 204, and configured to sense the position of roller 226, such that the position of roller can provide indication on the remaining content of the first composition in the pliable container. According to the position of the roller, the apparatus can be locked from operation, e.g. when the roller has not displaced for a predetermined period of time, such can indicate that no demand for edible paste has been received during said period of time, meaning that the pliable container needs to be replaced with a fresh one in order to prevent fermentation or contamination of the food ingredients.

While a single roller 226 is shown in this example, it is also contemplated that the auxiliary propelling arrangement includes two or more such rollers, for example two parallel rollers positionable along the front and back faces of the pliable container. In such an arrangement, the pliable container is positioned between the two parallel rollers, and the two parallel rollers can be jointly and synchronically moved along the pliable container to apply squeezing force onto both faces of the pliable container.

While the specific example shows the use of a pliable container for holding the first composition, it is also contemplated that the removable container can be a rigid or semi-rigid container in cases where the viscosity of the first composition permits such use.

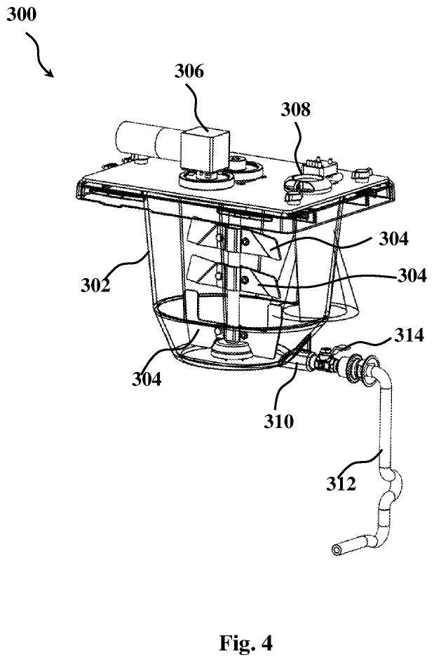

The reservoir assembly 300 is shown in FIG. 4. Reservoir 302 is configured to hold a second, typically plant-based, edible composition, which is in the form of an oil-based flowable paste having a viscosity of at most 5,000 cps, e.g. between 30 to 1,000 cps. For example, the second composition can be tahini. A plurality of mixing elements 304 are fitted within the reservoir, and are rotated by motor 306 to maintain the second composition under mixing conditions, e.g. to prevent phase separation or sedimentation of solid matter. For example, in the case the second composition is tahini, care should be taken to prevent separation of the oily phase from the ground sesame particles—hence, continuous mixing of the contents of the reservoir is carried out.

The reservoir 302 has one or more top openings 308, permitting re-filling the reservoir with the flowable second composition, or permitting introduction of cleaning fluid (e.g. water) in order to clean the reservoir. The reservoir can also be removably received with the apparatus, such that the reservoir can be taken out of the apparatus for cleaning and maintenance.

Formed at the bottom of reservoir 302 is a reservoir outlet 310, linked or linkable to second duct 312, permitting drawing portioned amounts of the second composition from the reservoir. Valve 314 is fitted at reservoir outlet 310, and is operable to permit or prevent flowing of the second composition from the reservoir to the second duct.

Turning to FIGS. 5A-5B, shown is the static mixing assembly that enables mixing of metered portions of the viscous first composition with metered portioned the flowable second composition in order to obtain a portion of the edible paste in the form of an emulsion.

The static mixing assembly, generally designated 500, includes first inlet 502 for receiving the first composition propelled through the first duct 222 from pliable container 202, and second inlet 504 for receiving the second composition propelled through the second duct 312 from the reservoir 302, and outlet 506, which is in flow communication with an edible paste dispensing outlet 110 of the apparatus. Static mixing arrangement 508 is disposed between the first and second inlets 502,504 and the outlet 506, configured to statically mix the first composition with the second composition while advancing within the static mixing arrangement from the inlets towards the outlet.

The first and second composition are propelled along the first and second ducts 222 and 312, respectively, and from the inlets 502,504 towards the outlet 506 by propelling modules 510, which in this example are peristaltic pumps, configured to apply peristaltic propulsion onto the first and second ducts, which are typically flexible tubing. Thus, the first and second compositions are propelled, i.e. fed under pressure and/or are being forced-fed, from the pliable container and the reservoir into the first and second inlets of the static mixing assembly, respectively, via the respective first and second ducts. The control module activates the propelling modules to propel portioned amounts of the first and second compositions through the static mixing assembly to thereby dispense said portioned edible paste. As can be appreciated, the propulsion modules enable propulsion of the first and second compositions through the ducts and within the static mixing arrangement without bringing the food ingredients into contact with the propulsion means.

As can be seen, the static mixing arrangement 508 is removably held by clamp 512, permitting removing static mixing arrangement 508 from the appliance for replacement. Preferably, the first duct 222, the second duct 312 and the static mixing arrangement 500 are integral with one another, and form a single replaceable unit.

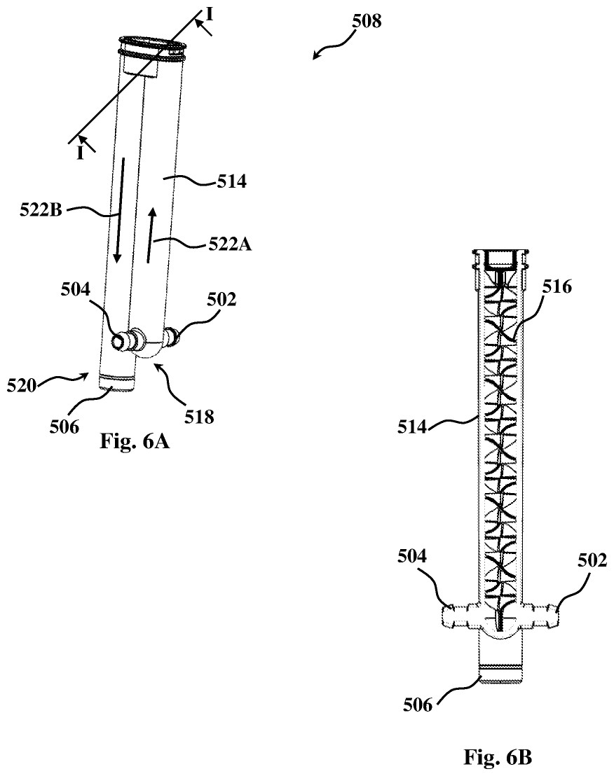

Seen in isolation in FIGS. 6A-6B is the static mixing arrangement 508. Static mixing arrangement 508 comprises an external tube 514 that encases an array of flow diverters or baffles 516, such that the compositions are intermixed as they are concomitantly force-fed and flow along the static mixer, i.e. causing the compositions to mix within a mixing unit that has no moving parts.

Tube 514 of this specific example is U-shaped, thereby enabling a compact arrangement, however permitting sufficient flow path to enable proper mixing of the viscous first composition with the flowable second composition. In this arrangement, the first and second inlets 502,504 and the outlet 506 are positioned at respective terminal segments 518,520 of the arms of the U-shaped tube 514, while first and second compositions are made to flow in the direction of arrows 522A,522B to obtain thorough mixing and formation of the edible paste and dispensing of a portion of edible paste.

The portioned amount of edible paste is typically a consumable amount, namely a single serving of the edible paste, i.e. an amount for consuming in a single meal. Hence, the apparatus is configured for batch-wise operation (i.e. not continuous), to prepare and dispense single servings of the edible paste in a sequence. The portion amount can be, for example, up to 500 g of the edible paste, e.g. between about 100 g and 500 g.

The arrangement permits a user to control the composition of the eventual edible paste to be produced, by permitting selection of the relative amounts of first and second compositions, and addition of desired toppings (in case such are provided). For example, the apparatus can be configured to mix the first composition and the second composition, such that the edible paste will contain the second composition in an amount of between about 5 wt % and about 50 wt % out of the total weight of the edible paste.

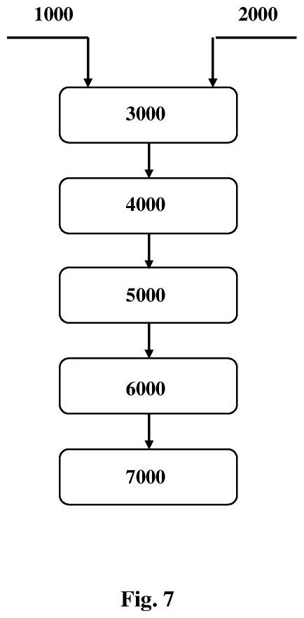

An exemplary process, or cycle of operation, for preparing a portioned edible paste is shown in FIG. 7. Upon demand for preparation of a portion of edible paste, input is entered by the user through the user interface, for example the desired portion size 1000 and the desired ratio between the first and second compositions 2000. The data entered causes the control module to actuate the apparatus for operation at 3000. The control module actuates the propulsion modules for operating at 4000, thereby causing drawing a suitable portion of the viscous first composition from the pliable container and simultaneously drawing a corresponding portion of the flowable second composition from the reservoir of the apparatus at 5000. The drawn portions are then further propelled by the propulsion modules towards the static mixing arrangement, into which the first and second compositions are force-fed and mixed at 6000 as they are forced to move along the static mixing arrangement, thereby obtaining the edible paste in the form of an emulsion. The edible paste is then dispensed at 7000, ready for user consumption.

Although the apparatus and processes have been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

1. An apparatus for on-demand preparation of a portioned edible paste, the apparatus comprising:
a container receptacle configured to removably receive a removable container containing a first edible composition in the form of an aqueous-based viscous paste;
a reservoir for holding a second edible composition, in the form of an oil-based flowable paste;
a static mixing assembly configured to mix the first composition with the second composition in order to obtain said edible paste in the form of an emulsion, the static mixing assembly having
an inlet arrangement with a first inlet for receiving said first composition and a second inlet for receiving said second composition,
an outlet in flow communication with an edible paste dispensing outlet of the apparatus, and
a static mixing arrangement disposed between said first and second inlets and said outlet for mixing the first composition with the second composition while advancing within said static mixing arrangement from the inlet arrangement towards the outlet;
a ducting arrangement comprising
a first duct configured to link between said removable container and said first inlet, and
a second duct configured to link between said reservoir and said second inlet;
one or more propelling modules for propelling (i) the first composition from said removable container through the first duct into the first inlet, and (ii) the second composition from said reservoir through the second duct into the second inlet; and
a control module for activating the one or more propelling modules to propel portioned amounts of the first and second compositions through the static mixing assembly and dispense said portioned edible paste.

2. The apparatus of claim 1, wherein at least one of said first composition and said second composition is plant-based.

3. (canceled)

4. (canceled)

5. (canceled)

6. The apparatus of claim 1, comprising a user interface module in communication with the control module to permit selection of one or more of:
(i) portion size of the portioned edible paste,
(ii) relative amounts of the first and second compositions.

7. The apparatus of claim 1, wherein said one or more propelling modules are peristaltic pumps.

8. The apparatus of claim 1, wherein the first edible composition is a legume paste.

9. The apparatus of claim 8, wherein the legume paste is a chickpea paste.

10. The apparatus of claim 1, wherein the second edible composition is in the form of an oil-based suspension.

11. The apparatus of claim 1, wherein the second edible composition is a sesame paste.

12. The apparatus of claim 1, wherein said removable container is a pliable container.

13. The apparatus of claim 12, wherein said pliable container is a pre-filled disposable container.

14. The apparatus of claim 12, wherein the container receptacle comprises an auxiliary propelling arrangement, configured for externally exerting a squeezing force onto the pliable container to thereby push the first edible composition towards the first duct.

15. The apparatus of claim 14, wherein the auxiliary propelling arrangement comprises one or more rollers.

16. The apparatus of claim 15, wherein said container receptacle comprises one or more sensors, configured to sense the position of said one or more rollers, such that the position of said one or more rollers provides indication on the remaining content of the first composition in the pliable container.

17. The apparatus of claim 12, wherein the pliable container has
a top end configured for coupling to the container receptacle,
a bottom end defining a confined volume containing said first plant-based edible composition, and
a fitting at said bottom end for coupling to said first duct.

18. The apparatus of claim 17, wherein the top end has a horizontal edge, and the bottom end has a slanted edge, downwardly extending from a first edge portion at one side of the container to a second edge portion at a second side of the container, said fitting being formed in a portion proximal to said second edge portion.

19. The apparatus of claim 17, wherein said first duct comprises a fitment end, and the fitting of the pliable container is configured to be irreversible ruptured by the fitment end during coupling of the first duct to the pliable container.

20. The apparatus of claim 17, wherein the container receptacle comprises one or more rollers configured for movement along a side of the container from said top end towards the bottom end to thereby exert a squeezing force onto the pliable container for pushing the first composition towards the fitting.

21. The apparatus of claim 17, wherein the container receptacle comprises two or more pins and the pliable container has holes at its top end configured for fitting over said pins.

22. (canceled)

23. The apparatus of claim 1, wherein the first duct, the second duct and the static mixing arrangement are disposable.

24. The apparatus of claim 23, wherein the first duct, the second duct and the static mixing arrangement are integral with one another, and form a single replaceable unit.

25. (canceled)

26. The apparatus of claim 1, wherein the reservoir is a rigid or semi-rigid tank, and comprises one or more mixing elements for continuously mixing the second edible composition.

27. The apparatus of claim 1, comprising a refrigeration module for refrigerating at least one of the first edible composition, the edible second composition and the edible paste.

28-45. (canceled)
